(19) United States
(12) Patent Application Publication
(10) Pub. No.: US 2024/0342630 A1
(43) Pub. Date: Oct. 17, 2024

(54) COMPACT PRESSURE ENERGY RECOVERY GAS OIL SEPARATION PLANT SYSTEMS AND METHODS

(71) Applicant: SAUDI ARABIAN OIL COMPANY, Dhahran (SA)

(72) Inventors: Samusideen Adewale SALU, Ras Tanura (SA); Abdulrahman ALHUMUD, Ghirnatah (SA)

(73) Assignee: SAUDI ARABIAN OIL COMPANY, Dhahran (SA)

(21) Appl. No.: 18/298,824

(22) Filed: Apr. 11, 2023

(51) Int. Cl. B01D 17/12; B01D 17/04; B01D 17/06; B01D 19/00; B03C 5/02; C10G 31/08; C10G 31/10; C10G 33/02; C10G 33/04; C10G 33/06; C10G 53/02

(52) U.S. Cl. CPC B01D 17/12; B01D 17/045; B01D 17/06; B01D 19/0026; B03C 5/02; C10G 31/08; C10G 31/10; C10G 33/02; C10G 33/04; C10G 33/06; C10G 53/02; C10G 2300/1033

(57) ABSTRACT

A compact pressure energy recovery gas oil separation plant system includes a rotary separation turbine (RST) that receives a wild crude oil and separates at least 95% of gas and free water from the wild crude oil and discharges an RST outlet crude stream, a wet-dry heat exchanger for heating the RST outlet crude stream, thereby producing an exchanger outlet crude stream, a three-phase high-pressure-high-temperature (HPHT) separator that receives and separates gas and water from the exchanger outlet crude stream to achieve a Basic Sediment & Water specification of 0.2 v/v % or less, thereby producing an HPHT outlet crude stream, a high-pressure desalter and dehydrator (HPDD) that receives, desalts, and dehydrates the HPHT outlet crude stream, thereby further and producing an HPDD outlet crude stream, and a high-pressure stabilization column that receives and stabilizes the HPD outlet crude stream, thereby producing an export grade crude stream.

### FIELD OF THE DISCLOSURE

The present disclosure relates generally to processing crude oil from an oil well and, more particularly, to compact pressure energy recovery gas oil separation plant systems and methods.

### BACKGROUND OF THE DISCLOSURE

Gas oil separation plant (GOSP) systems are often employed in the upstream oil and gas industry to process raw multiphase crude oil obtained from oil wells. Such raw crude oil includes a mixture of liquid hydrocarbons, gas, and saline (salt) formation water. The main function of GOSP systems is to adequately treat the raw multiphase crude oil by separating the gas and saline formation water from the liquid hydrocarbons to acceptable specifications for effective transportation and downstream processing. For example, excessive salt and water in crude oil can result in high corrosion of transportation pipelines and refining units and can also have detrimental scaling effects on processing units and catalysts. Furthermore, unstable crude oil can result in high vaporization in transportation vessels during shipping across regions of high temperature, leading to the potential of catastrophic explosion and major pollution to marine environment.

Conventional GOSP systems typically require a multitude of process equipment arranged in series and flow line requirements, resulting in the need for large energy requirements, operational and maintenance costs, and large and costly facilities to house GOSP systems.

What is needed is an alternative GOSP system that alleviates the aforementioned disadvantages associated with conventional GOP systems while meeting acceptable specifications for effective transportation and downstream processing.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a compact pressure energy recovery gas oil separation plant system is provided, the system including a rotary separation turbine (RST) that receives a wild crude oil and separates at least 95% of gas and water from the wild crude oil and discharges an RST outlet crude stream; a wet-dry heat exchanger for heating the RST outlet crude stream, thereby producing an exchanger outlet crude stream; a three-phase high-pressure-high-temperature (HPHT) separator that receives and separates gas and water from the exchanger outlet crude stream to achieve a Basic Sediment & Water specification of 0.2 v/v % or less, thereby producing an HPHT outlet crude stream; a high-pressure desalter and dehydrator (HPDD) that receives, desalts, and dehydrates the HPHT outlet crude stream, thereby further and producing an HPDD outlet crude stream; and a high-pressure stabilization column that receives and stabilizes the HPD outlet crude stream, thereby producing an export grade crude stream.

According to an embodiment consistent with the present disclosure, a method is provided, the method including introducing a wild crude oil to a rotary separation turbine (RST) and thereby operating the RST to separate at least 95% of gas and water from the wild crude oil and produce an RST outlet crude stream; conveying the RST outlet crude stream through a wet-dry heat exchanger and thereby heating the RST outlet crude stream and producing an exchanger outlet crude stream; separating gas and water from the exchanger outlet crude stream in a three-phase high-pressure-high-temperature (HPHT) separator and thereby producing an HPHT outlet crude stream that exhibits a Basic Sediment & Water specification of 0.2 v/v % or less; desalting and dehydrating the HPHT outlet crude stream in a high-pressure desalter and dehydrator (HPDD) and thereby producing an HPDD outlet crude stream; stabilizing the HPDD outlet stream in a high-pressure stabilization column; and discharging an export grade crude stream from the high-pressure stabilization column.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a simplified, schematic diagram of a conventional (prior art) GOSP system.

FIG. 2 is a schematic diagram of an example CPER-GOSP system, according to one or more embodiments.

### DETAILED DESCRIPTION

Embodiments of the present disclosure will now be described in detail with reference to the accompanying Figures. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to processing crude oil from an oil well and, more particularly, to compact pressure energy recovery gas oil separation plant (CPER-GOSP) systems and methods. As described in detail below, the CPER-GOSP systems utilize a multiphase flow rotary separation turbine operable to recover energy from high-pressure fluid (crude) and separate liquid (water) and gas from the crude using hydrodynamics. Utilizing the rotary separation turbine may prove advantageous in minimizing the number of required process equipment and flow lines to properly treat the incoming crude. The CPER-GOSP systems produce electrical power for use as part of the CPER-GOSP system or other facility operations. Accordingly, the CPER-GOSP systems of the present disclosure reduce both project capital expenditure (CAPEX) and operating expenditure (OPEX), reduce plant processing equipment count, conserve energy usage, and generate electrical power for utilities consumption.

### Prior Art GOSP System

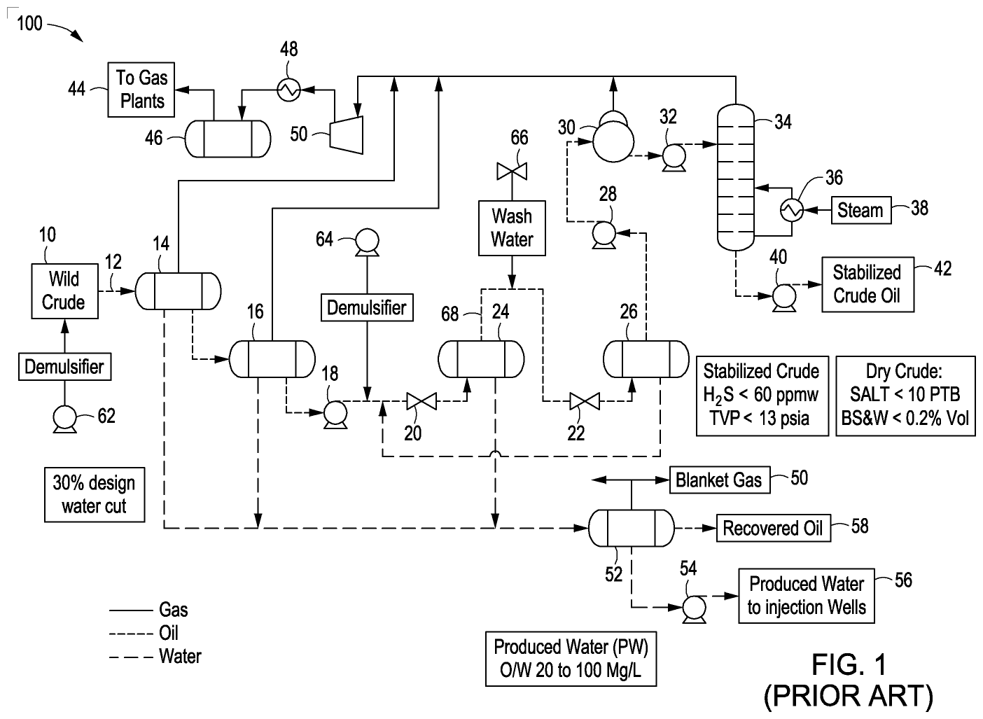

Before describing the CPER-GOSP systems and methods of the present disclosure, a simplified, schematic conventional (prior art) GOSP system 100 is described with reference to FIG. 1. The GOSP 100 may be configured to receive and process crude oil and, more particularly, to remove hydrocarbon gas and water from the incoming crude oil.

GOSP 100 receives wild/wet crude 10 from an upstream field (e.g., an oil well) via a trunk line 12 that feeds the crude into a three-phase separation vessel, such as a High Pressure Production Trap (HPPT) separator 14, where the first stage of gas and free water separation from the crude takes place. The separated wet crude discharged from the HPPT 14 is fed into a second stage three-phase separation vessel, such as a Low Pressure Production Trap (LPPT) separator 16 for further separation of more gas and water from the crude at a lower pressure. In some example GOSP configurations, the wet crude from the LPPT 16 may also be channeled through one or more wet/dry heat exchanger(s) into a three-phase Low Pressure Degassing Tank (LPDT) or separator that normally operates at almost atmospheric pressure (circa 3 psig) for more gas and water to be removed from the wet crude 10. It should be noted, however, that the two additional unit operations, for example, wet/dry heat exchanger and LPDT are not shown in the GOSP illustrated in FIG. 1 as they are considered optional.

The wet crude oil from the LPPT 16 (or LPDT) is transferred by one or more crude charge pumps 18 into Wet Crude Handling Facilities (WCHF) via mixing valves 20, 22. The WCHF may include a Wet Crude Handling (WCH) dehydrator 24 and a single/double stage WCH desalter 26. The crude 10 must be treated in the WCHF to meet first the Basic Sediment & Water (BS&W) specification of 0.2 v/v % or less and then the salt content of less than 10 PTB (pounds per thousand barrels). The dehydrated/desalted crude is then pumped into an atmospheric spheroid or degassing tank 30 via shipper pump 28 and then flows to a crude stabilizer column 34 via booster pump 32, where it is stripped of volatile components and stabilized to export grade crude specification of 13 TVP (True Vapor Pressure) at 130° F. and its H2S content removed to a required specification of less than 60 ppm wt. (parts per million by weight) H2S. Optionally, steam 38 may be injected into the crude after emerging from the reboiler 36 and before entering into the crude stabilizer 34.

The produced export grade crude or stabilized oil 42 is finally pumped by one or more shipper pumps 40 to its export terminal or refinery destination. The gas streams from the production traps 14, 16, degassing tank 30, and stabilizer 34 flow to the gas gathering compression system for onward delivery to gas processing plants 44.

Each stage of the compression plant consists of a gas compressor 50, a compressor discharge cooler 48, and a compressor discharge gas knock-out vessel 46.

The water stream from the productions traps 14, 16 and the WCH dehydrator 24 is pumped to a Water Oil Separator (WOSEP) 52, where the WOSEP separates water 56 from recovered oil 58. Blanket gas 60 is used to maintain normal operating pressure in the WOSEP 52. The WOSEP 52 removes the oil content of inlet-produced water to less than 100 ppm at the outlet as the disposal water, which is injected, via an injection pump 54, back downhole (e.g., into a reservoir) for water flooding and pressure maintenance.

As shown in FIG. 1, there are two points 62, 64 for demulsifier injection in the GOSP 100. The first injection point 62 is upstream of the high-pressure production trap 14 at the inlet 12 of the plant which is referred to as the primary demulsifier injection. The second injection point 64 is at upstream of the Wet Crude Handling Facilities 24, 26, which is referred to as secondary/emergency demulsifier injection. The wash water 66 is injected into the dehydrated crude 68 entering the desalter 26 to meet the salt content specification of the produced crude.

Accordingly, in conventional GOSP systems, a feed (wild) crude oil is separated into its gas and liquid phases (gas and oil) by stage-wise letting down of the upstream pressure in a series of vessels, recompression of the separated gases in a similar series of compressor stages, and pumping the separated liquid for export to desired destinations. Thus, conventional GOSP systems require installation of a series of various equipment, such as separation vessels, rotating equipment (pumps, compressors, etc.), and the like, that require substantial energy consumption to operate.

### The CPER-GOSP System

Unlike the conventional GOSP system 100, the compact pressure energy recovery gas oil separation plant (CPER-GOSP) systems of the present disclosure comprise power recovery systems utilizing a multiphase flow rotary separation turbine to recover energy from the wild crude (i.e., high-pressure fluid) and separate water and gas from the liquid oil by hydrodynamics means. The CPER-GOSP systems described herein are able to do this with a minimum amount of process equipment to meet industry separation standards of feed (wild) crude oil separation.

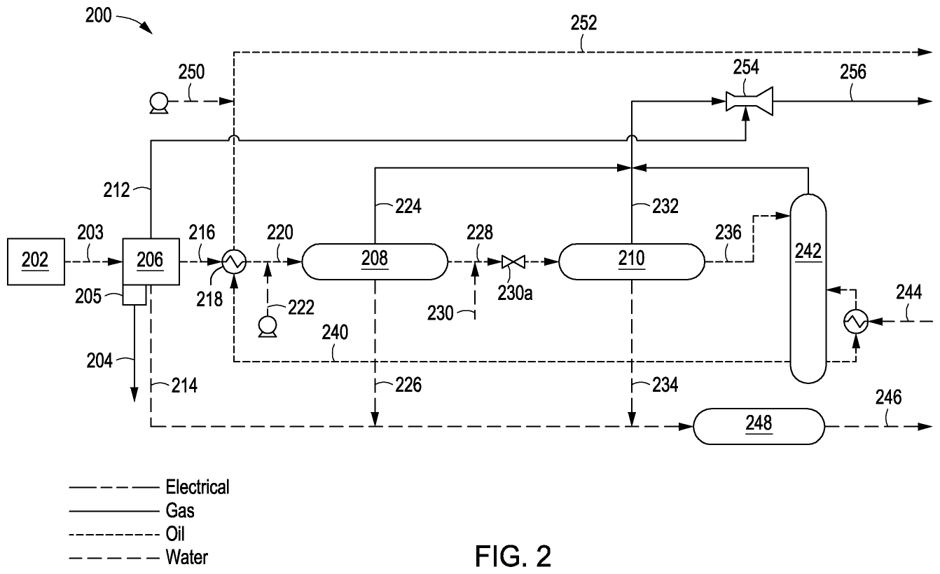

Referring now to FIG. 2, illustrated is a schematic of an example CPER-GOSP system 200, according to one or more aspects of the present disclosure. The CPER-GOSP 200 may be similar in some respects to the GOSP system 100, and therefore may be best understood with reference thereto. The CPER-GOSP 200 receives a multiphase feed wild/wet crude stream 202 from an upstream field (e.g., an oil well) via a trunk line 203. The CPER-GOSP 200 separates the wild/wet crude stream 202 from associated gas and water using a rotary separation turbine (RST) 206, a three-phase high-pressure-high-temperature separator 208 (HPHT separator 208) equipped with Vessel Internal Electrostatic Coalescer (VIEC), and a combined high-pressure desalter and dehydrator 210 (HPDD) equipped with a VIEC. As used herein, the term “Vessel Internal Electrostatic Coalescer” or “VIEC,” and grammatical variants thereof, refers to a technology using alternating high voltage electrical fields for enhancing liquid-liquid separation by Wartsila Corporation of Helsinki, Finland.

Initially, the wild/wet crude stream 202 is fed to the RST 206, which uses the pressure and flow of the wild/wet crude stream 202 to operate the RST 206 and thereby produce a RST outlet gas stream 212, a RST outlet water stream 214, and a RST outlet wet crude stream 216 (i.e., separation of the feed wild/crude stream 202). It is to be noted that the feed wet/crude stream 202 is relatively cold, having a temperature in the range of about 60° F. to about 160° F., and encompassing any value and subset therebetween. In a specific example, the temperature of the feed wild/crude stream 202 is about 150° F.

The RST 206 may be operable to initially separate at least about 95% of gas (represented as the RST outlet gas stream 212) from the feed wild/crude stream 202, including up to 98% of gas separation, and encompassing any value and subset therebetween. The RST 206 may further be operable to initially separate at least about 95% of non-emulsion free water (represented as the RST outlet water stream 214), including up to 99% free water separation, encompassing any value and subset therebetween. Accordingly, any emulsion water and residual gas included in the RST outlet wet crude stream 216 may primarily be in solution.

As shown, the RST 206 includes or is otherwise operatively coupled to a generator 205 that is rotated to generate electrical power 204 as the RST 206 operates. The electrical power 204 may be used for a variety of purposes, such as supplying power to facility utilities in which the CPER-GOSP 200 operates. Moreover, the RST 206 comprises turbine blades that are capable of maintaining high pressure for discharging the RST outlet gas stream 212, the RST outlet water stream 214, and the RST outlet wet crude stream 216.

With continued reference to FIG. 2, after the RST 206 processes the wild/crude stream 202, the resultant RST outlet wet crude stream 216 may be fed through a wet-dry heat exchanger 218 to produce a higher-temperature, exchanger outlet wet crude stream 220. The wet-dry heat exchanger 218 serves to cross-exchange heat with a relatively hot stabilized crude stream 240 discharged from a high-pressure crude stabilizer 242, as described in more detail below, for export to an export terminal, pipeline, or refinery destination, as also described herein. The wet-dry heat exchanger 218 may serve advantageously as a heat economizer, wherein the relatively cold RST outlet wet crude stream 216 (i.e., see temperature range for the feed wild/crude stream 202) is heated by the stabilizer outlet wet crude stream 240, as required to enhance gas and emulsion water separation in subsequent process equipment. Further, the relatively hot stabilizer outlet wet crude stream 240 must be cooled to meet the pipeline and downstream (terminal/refinery) tank specifications.

Upon emerging from the wet-dry heat exchanger 218, the exchanger outlet wet crude stream 220 may have a temperature in the range of about 200° F. to about 240° F., and encompassing any value and subset therebetween. In some aspects, upon emerging from the wet-dry heat exchanger 218, the exchanger outlet wet crude stream 220 may have a temperature of about 230° F. Further, upon emerging from the wet-dry heat exchanger 218, in some embodiments, the exchanger outlet wet crude stream 220 may be dosed with a demulsifier 222. Demulsifier(s) 222 are chemicals used to separate emulsions, such as water-in-oil emulsions. An example of a suitable demulsifier 222 for use in the present disclosure includes, but is not limited to, PHASETREAT® (Clariant of Muttenz, Switzerland). In one or more instances, the demulsifier 222 may be added to the exchanger outlet wet crude stream 220 in an amount in the range of about 20 ppm vol (parts per million by volume) to about 50 ppm vol, encompassing any value and subset therebetween, depending on the type of feed wild/crude stream 202, for example.

The exchanger outlet wet crude stream 220, dosed with the demulsifier(s) 222, may be fed into the HPHT separator 208 to produce an outlet gas stream 224, an outlet water stream 226, and an outlet wet crude stream 228. The HPHT separator 218 may be operable to separate free and in-solution gases to achieve gas separation of the resultant outlet wet crude stream 228 in the range of about 95% to about 99%, encompassing any value and subset therebetween, without letting down fluid pressure and using only temperature increase to achieve gas separation. Moreover, in embodiments where the HPHT separator 208 includes the VIEC, the HPHT separator 208 may also be operable to separate both free water and water-in-emulsion (i.e., water-in-oil) due to the inclusion of the demulsifier 222. The HPHT separator 218 is further capable of achieving water separation meeting BS&W specification of less than 0.2 v/v %.

The outlet wet crude stream 228 is fed into the HPDD 210 for desalting and dehydration, the dehydration made possible by the VIEC component of the HPDD 210. Prior to being fed into the HPDD 210, the outlet wet crude stream 228 may optionally be injected with wash water 230, which is mixed with the outlet wet crude stream 228 using a mixing valve 230a. Injection of the wash water 230 may be configured to meet a salt content concentration of less than 10 pounds per thousand barrels (PTB) for feeding into the HPDD 210, while maintaining the BS&W requirement of 0.2 v/v % or less.

The HPDD 210 produces an outlet gas stream 232, an outlet water stream 234, and an outlet wet crude stream 236. The HPDD 210 may be configured to separate additional gas from the HPHT outlet wet crude stream 228 with little pressure drop at the inlet of the HPDD 210 for the purpose of mixing the wash water 230 with the outlet wet crude stream 228, whereas normal mixing requires a 10-15 pressure drop. The HPDD 210 further advantageously handles receipt of the outlet wet crude stream 228 (and wash water 230) while meeting a salt content concentration of less than 10 pounds per thousand barrels (PTB) for further downstream processing while maintaining the BS&W requirement of 0.2 v/v % or less.

The outlet wet crude stream 236 is desalted and dehydrated and may be fed to a high-pressure crude stabilizer 242 where it is stripped of volatile components and stabilized to produce a stabilized crude stream 240, as described below. As used herein, the term “stabilized,” and grammatical variants thereof, refers to lowering the vapor pressure and thus volatile components of a crude oil to facilitate tank storage and pipeline transport. The stabilization may be, for example, to lower the vapor pressure of a crude oil to at least 13 pounds per square inch (psi) or less at 37.8° C. so that vapor will generally not flash under atmospheric conditions and to reduce volatile components, such as to reduce H2S to an industry specification content of less than about 60 ppm wt., particularly in the case of sour crude, or in the range of about 10 ppm wt. to about 60 ppm. wt., encompassing any value and subset therebetween. In some instances, the stabilization reduces the volatile components, such as to reduce H2S to an industry specification content of less than about 10 ppm wt.

The temperature and number of column tray/stages of the stabilizer 242 may be determined using process simulation software, such as ASPEN-HYSYS (AspenTech, Massachusetts) to achieve the aforementioned stabilized crude stream qualities. Where a very high stabilizer 242 temperature is required in order to meet stringent H2S content specifications, direct injection of dry steam 244 may be injected into the stabilizer 242. Moreover, optional H2S scavenger(s) 250, such as PETROSWEET™ HSO3507 (Baker Hughes, Texas), may be mixed with the produced stabilized crude stream 240 to support the H2S stripping.

The produced export grade crude stream 252 is finally cooled and flows at operating pressure without the need for additional pumping to its export Terminal or Refinery destination (not shown).

In some embodiments, the gas streams 212, 224, and 232 are comingled and otherwise combined in an optional ejector 254. The ejector 254 utilizes the Venturi effect based on Bernoulli's principle of a converging-diverging nozzle to convert the energy of the higher-pressure gas stream 212 to velocity energy, which creates a low pressure zone within the ejector 254 that draws in and entrains the remaining lower-pressure gas streams 224, 232. A mixture 256 of the gas streams 212, 224, and 232 may then be discharged from the ejector 254 and conveyed to a gas processing plant without any need for additional pressurization.

The water streams 214, 226, and 234 may be conveyed to a Water-Oil Separator (WOSEP) 248 to remove the remaining oil content to less than 100 ppm, and discharge a water stream 246 that may be injected back into a subterranean reservoir for water-flooding and/or pressure maintenance.

The CPER-GOSP systems and methods of the present disclosure are operable to refine wild/crude oil to produce a stabilized export crude oil product safe for storage and shipment and meeting the following specifications: (1) a salt concentration of not more than about 10 pound (lbs.) of salt/1000 barrels (PTB); (2) basic sediment and water (BS&W) of not more than about 0.2 volume percent (V %); (3) H2S concentration of less than about 60 ppm (in the range of 10 ppm to 60 ppm); and (4) a maximum true vapor pressure (TVP) of about 13 psia at 37.8° C.

Further, the CPER-GOSP comprises a limited number of major process equipment, including: (1) a RST system to generate electrical power and separate gas and liquid phase; (2) a wet-dry crude heat exchanger (with or without an extra crude heater); (3) a HPHT-VIEC; (4) a HPDD-VIEC; and (5) a high-pressure stabilization column.

In addition to the aforementioned major process equipment, the CPER-GOSP may further include the following utility systems: (1) steam/hot oil from solar concentrator/molten salt technology for crude oil heating in the CPER-GOSP; (2) wash water storage and circulation for use in crude oil desalting; (3) chemical injection packages (e.g., demulsifier, corrosion inhibitor, scale inhibitor, H2S Scavenger, and the like); (4) a utility and fire water system; (5) a relief and flare system; (6) a fuel gas system; (7) power generation; and (8) utility & instrument air and nitrogen systems.

Accordingly, the CPER-GOSP of the present disclosure serves stringent economic challenges in the oil and gas industry and the need for energy conservation and net-zero emissions targets, which producing electrical power for energy demands.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The invention claimed is:

1. A compact pressure energy recovery gas oil separation plant system, the system comprising:
a rotary separation turbine (RST) that receives a wild crude oil and separates at least 95% of gas and water from the wild crude oil and discharges an RST outlet crude stream;
a wet-dry heat exchanger for heating the RST outlet crude stream, thereby producing an exchanger outlet crude stream;
a three-phase high-pressure-high-temperature (HPHT) separator that receives and separates gas and water from the exchanger outlet crude stream to achieve a Basic Sediment & Water specification of 0.2 v/v % or less, thereby producing an HPHT outlet crude stream;
a high-pressure desalter and dehydrator (HPDD) that receives, desalts, and dehydrates the HPHT outlet crude stream, thereby further and producing an HPDD outlet crude stream; and
a high-pressure stabilization column that receives and stabilizes the HPD outlet crude stream, thereby producing an export grade crude stream.

2. The system of claim 1, further comprising a generator operatively coupled to the RST and operable to generate electrical power as the RST operates.

3. The system of claim 1, wherein the HPHT separator includes a Vessel Internal Electrostatic Coalescer (VIEC) operable to separate both free water and water-in-emulsion from the exchanger outlet crude stream.

4. The system of claim 1, wherein the HPDD includes a Vessel Internal Electrostatic Coalescer (VIEC) operable to dehydrate the HPHT outlet crude stream.

5. The system of claim 1, further comprising an ejector that receives corresponding gas streams discharged from the RST, the HPHT, and the HPDD, the ejector being configured to discharge a mixture of the corresponding gas streams and convey the mixture downstream.

6. The system of claim 1, wherein the export crude stream has a salt concentration of less than about 10 pound (lbs.) of salt/1000 barrels.

7. The system of claim 1, wherein the export crude stream has basic sediment and water of less than about 0.2 v/v %.

8. The system of claim 1, wherein the export crude stream has a H2S concentration of less than about 60 ppm.

9. The system of claim 1, wherein the export crude stream has a maximum true vapor pressure of about 13 psia at 37.8° C.

10. A method comprising:
introducing a wild crude oil to a rotary separation turbine (RST) and thereby operating the RST to separate at least 95% of gas and water from the wild crude oil and produce an RST outlet crude stream;
conveying the RST outlet crude stream through a wet-dry heat exchanger and thereby heating the RST outlet crude stream and producing an exchanger outlet crude stream;
separating gas and water from the exchanger outlet crude stream in a three-phase high-pressure-high-temperature (HPHT) separator and thereby producing an HPHT outlet crude stream that exhibits a Basic Sediment & Water specification of 0.2 v/v % or less;
desalting and dehydrating the HPHT outlet crude stream in a high-pressure desalter and dehydrator (HPDD) and thereby producing an HPDD outlet crude stream;
stabilizing the HPDD outlet stream in a high-pressure stabilization column; and
discharging an export grade crude stream from the high-pressure stabilization column.

11. The method of claim 10, further comprising generating electrical power as the RST operates with a generator operatively coupled to the RST.

12. The method of claim 10, further comprising separating both free water and water-in-emulsion from the exchanger outlet crude stream with a Vessel Internal Electrostatic Coalescer (VIEC) included in the HPHT separator.

13. The method of claim 10, further comprising dehydrating the HPHT outlet crude stream with a Vessel Internal Electrostatic Coalescer (VIEC) included in the HPDD.

14. The method of claim 10, further comprising:
receiving corresponding gas streams discharged from the RST, the HPHT, and the HPDD at an ejector; and
discharging a mixture of the corresponding gas streams from the ejector and conveying the mixture downstream.

15. The method of claim 10, further comprising introducing a demulsifier to the exchanger outlet crude stream.
